(19) United States
(12) Patent Application Publication
(10) Pub. No.: US 2018/0113615 A1
(43) Pub. Date: Apr. 26, 2018

(54) STORAGE DEVICE GENERATING ADAPTIVE INTERRUPT AND OPERATING METHOD THEREOF

(71) Applicant: SAMSUNG ELECTRONICS CO., LTD., Suwon-si (KR)

(72) Inventor: JunBum PARK, Suwon-si (KR)

(73) Assignee: SAMSUNG ELECTRONICS CO., LTD., Suwon-si (KR)

(21) Appl. No.: 15/702,275

(22) Filed: Sep. 12, 2017

(30) Foreign Application Priority Data
Oct. 24, 2016 (KR) 10-2016-0138584

(51) Int. Cl. G06F 3/06; G06F 13/24

(52) U.S. Cl. CPC G06F 3/061; G06F 3/0655; G06F 3/0679; G06F 13/24

(57) ABSTRACT

Disclosed is a data storage device which includes one or more storage elements and a controller. The controller executes a command of the host, updates a completion queue of a host, and transfers an interrupt to the host. The controller monitors a completion queue tail doorbell and a completion queue head doorbell and generates the interrupt based on the monitoring result. The data storage device may generate an interrupt in consideration of a status of the completion queue. Therefore, performance of the host may be improved by the data storage device.

### CROSS-REFERENCE TO RELATED APPLICATIONS

This application claims priority from Korean Patent Application No. 10-2016-0138584, filed on Oct. 24, 2016 in the Korean Intellectual Property Office, the entire contents of which are hereby incorporated by reference.

### BACKGROUND

### 1. Field

Apparatuses and methods consistent with exemplary embodiments relate to a storage device and an operating method thereof, and more particularly, to a data storage device that adaptively generates an interrupt and an operating method thereof.

### 2. Description of the Related Art

A flash memory device is being used as voice and image data storage media of information devices such as a computer, a smart phone, a personal digital assistant (PDA), a digital camera, a voice recorder, an MP3 player, a handheld computer, and the like. An example of a flash memory-based mass storage device is a solid-state drive (“SSD”). The use of the SSD has diversified as the demand for the SSD increased. For example, the SSDs may be subdivided into SSD for server, SSD for client, SSD for data center, etc. An interface of the SSD may be designed to provide the best speed and reliability to be suitable for the use of the SSD. In this case, performance of a controller of the SSD may be markedly improved.

As the performance of the SSD controller improves markedly, the SSD controller may perform a host-requested operation rapidly and frequently generate an interrupt that the host will process. If the controller frequently generates the interrupt, the host may frequently perform an interrupt service routine, thereby reducing performance of the host. Accordingly, there is a need for a data storage device that generates an interrupt in consideration of the performance of the host.

### SUMMARY

Embodiments of the inventive concept provide a data storage device that adaptively generates an interrupt and an operating method thereof.

According to an aspect of an exemplary embodiment, a data storage device may include one or more storage elements and a controller. The controller may execute a command of the host, update a completion queue of a host, and transfer an interrupt to the host. The controller may monitor a completion queue tail doorbell and a completion queue head doorbell, and generate the interrupt based on the monitoring result.

According to an aspect of an exemplary embodiment, an operating method of a data storage device may include executing a command of the host and updating a completion queue of the host, monitoring a completion queue tail doorbell and a completion queue head doorbell stored in the data storage device, and transferring an interrupt to the host based on the monitoring result.

### BRIEF DESCRIPTION OF THE DRAWINGS

FIG. 1 is a block diagram illustrating a computer system to which a data storage device is applied, according to an exemplary embodiment;

FIG. 2 is an exemplary sequence diagram illustrating an operation between a host and a data storage device illustrated in FIG. 1;

FIGS. 3 and 4 are exemplary timing diagrams illustrating an operation of a controller illustrated in FIG. 1;

FIG. 5 is exemplary table illustrating operations of a controller and a host illustrated in FIG. 1;

FIG. 6 is a flowchart illustrating an exemplary operation of a controller illustrated in FIG. 1;

FIG. 7 is an exemplary flowchart illustrating operation S250 illustrated in FIG. 6;

FIG. 8 is an exemplary block diagram illustrating a controller illustrated in FIG. 1;

FIG. 9 is an exemplary block diagram illustrating a controller illustrated in FIG. 1; and

FIG. 10 is an exemplary block diagram illustrating a computer system to which a nonvolatile memory device is applied, according to an embodiment of the inventive concept.

### DETAILED DESCRIPTION

Reference will now be made in detail to exemplary embodiments, with reference to the accompanying drawings. In the drawings, parts irrelevant to the description are omitted to clearly describe the exemplary embodiments, and like reference numerals refer to like elements throughout the specification. In this regard, the present exemplary embodiments may have different forms and should not be construed as being limited to the descriptions set forth herein.

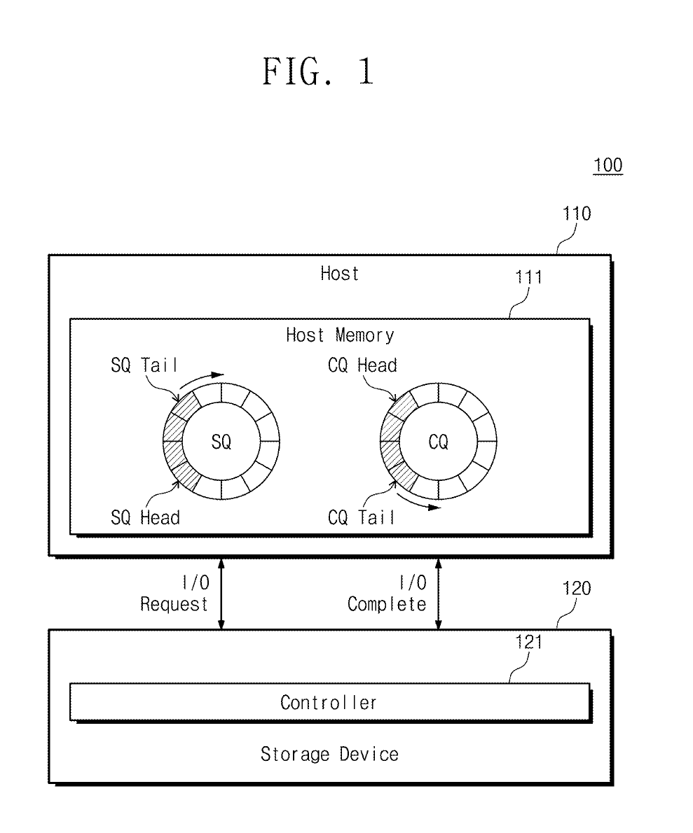

FIG. 1 is a block diagram illustrating a computer system to which a nonvolatile memory device is applied, according to an exemplary embodiment. As shown in FIG. 1, a computer system 100 may include a host 110 and a data storage device 120.

The host 110 may write data in the data storage device 120 or may read data from the data storage device 120. To this end, the host 110 generates various commands for writing data in the data storage device 120 or reading data from the data storage device 120.

Referring to FIG. 1, the host 110 may include a host memory 111. An application program or data to be processed by the host 110 may be loaded on the host memory 111. In particular, the host memory 111 may include a submission queue SQ and a completion queue CQ. The submission queue SQ may be a queue written to by the host 110. The submission queue SQ may be used to store one or more commands generated by the host 110. The completion queue CQ may be a queue written to by the data storage device 120. The completion queue CQ may be used to store completion information about commands requested by the host 110. Each of the submission queue SQ and the completion queue CQ is illustrated by a circle. However, the particular shape of each of the submission queue SQ and the completion queue CQ is chosen for illustrations purposes only, and the queues may be implemented in any number of ways. If any physical address range for the submission queue SQ and the completion queue CQ is designated in the host memory 111, memory cells corresponding to the address range may be designated as the submission queue SQ or the completion queue CQ.

In FIG. 1, the host 110 may generate a command for using the data storage device 120 and may store the command in the host memory 111. Specifically, the command generated by the host 110 may be stored in a submission queue entry of the host memory 111. The command generated by the host 110 may be continuously stored in a submission queue entry in the direction of an arrow. The host 110 may store a command in a submission queue entry and may update a position of a submission queue tail. To this end, the host 110 may update a submission queue tail doorbell SQTDBL of the controller 121. Here, the submission queue tail doorbell SQTDBL, which is a value stored in a SQTDBL register, may be a pointer that indicates a submission queue tail.

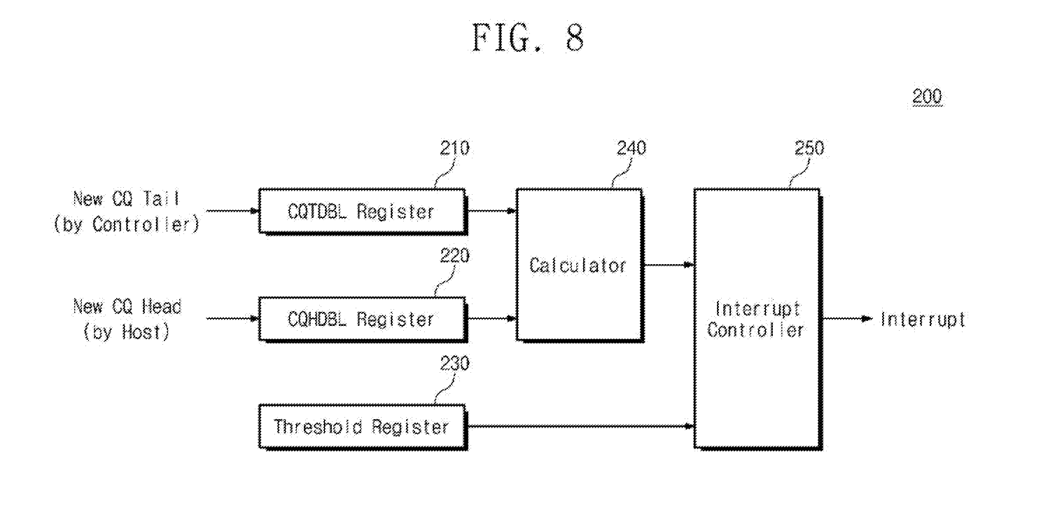

The data storage device 120 may process a host command. In particular, the data storage device 120 may include the controller 121. The controller 121 may fetch a command generated by the host 110 with reference to the submission queue SQ. In more detail, the controller 121 may refer to the submission queue tail doorbell SQTDBL. The controller 121 may fetch a submission queue entry sequentially in the direction of the arrow from the submission queue head towards the submission queue tail. After the fetch operation, the controller 121 may completely process a command stored in the submission queue entry. After completely processing the command, the controller 121 may write a status of the completed command in a completion queue entry of the host memory 111. The controller 121 may store the status of the completed command in the completion queue entry sequentially in the direction of the arrow. The host 110 may store the status of the completed command in a completion queue entry and may update a position of a completion queue tail. The controller 121 may update a completion queue tail doorbell CQTDBL, which will be described with reference to FIG. 8. Here, the completion queue tail doorbell CQTDBL, which is a value stored in a CQTDBL register, may be a pointer that indicates a completion queue tail.

The host 110 may process a completion queue entry again. The host 110 may process completion information and may update a position of a completion queue head. Also, the host 110 may transfer information of the updated completion queue head to the controller 121. To this end, the host 110 may update a completion queue head doorbell CQHDBL (to be described with reference to FIG. 8) of the controller 121. Here, the completion queue head doorbell CQHDBL, which is a value stored in a CQHDBL register, may be a pointer that indicates a completion queue head.

The controller 121 may generate an interrupt such that a completion queue entry is processed by the host 110 and may transfer the interrupt to the host 110. The host 110 may perform an interrupt service routine (ISR) in response to the interrupt. According to the interrupt service routine, the host 110 may check a completion queue tail and may process a completion queue entry.

According to an aspect of an exemplary embodiment, the controller 121 may monitor the completion queue CQ and may generate an interrupt based on the monitoring result. To monitor the completion queue CQ, the controller 121 may check the completion queue tail doorbell CQTDBL and the completion queue head doorbell CQHDBL. As described above, the controller 121 may completely process a command of the host 110 and may update the completion queue tail doorbell CQTDBL. Accordingly, the controller 121 may check a completion queue tail with reference to the completion queue tail doorbell CQTDBL. Also, the host 110 processes a completion queue entry and may update the completion queue head doorbell CQHDBL of the controller 121. Accordingly, the controller 121 may check a completion queue head with reference to the completion queue head doorbell CQHDBL.

A difference (i.e., positional distance) between the completion queue tail doorbell CQTDBL and the completion queue head doorbell CQHDBL may indicate a status of the completion queue CQ. That is, a difference between the completion queue tail doorbell CQTDBL and the completion queue head doorbell CQHDBL may indicate the number of completion queue entries that are not processed by the host 110. For example, in the case where the host 110 performs the interrupt service routine mostly on time, a difference between the completion queue tail doorbell CQTDBL and the completion queue head doorbell CQHDBL may be relatively small. In contrast, in the case where the host 110 fails to perform the interrupt service routine on time, a difference between the completion queue tail doorbell CQTDBL and the completion queue head doorbell CQHDBL may be relatively large. That is, a completion queue entry may become pending according to a status of the host 110. In this case, if the controller 121 generates an interrupt, the performance of the host 110 may be reduced.

According to an aspect of an exemplary embodiment, the controller 121 may generate an interrupt when a difference between the completion queue tail doorbell CQTDBL and the completion queue head doorbell CQHDBL is small. That is, in the case where the host 110 performs the interrupt service routine mostly on time, the controller 121 may generate an interrupt. In the case where the host 110 fails to perform the interrupt service routine on time, the controller 121 may withhold generating an interrupt. That is, the controller 121 may adaptively generate an interrupt (or may generate an adaptive interrupt) to improve the performance of the host 110.

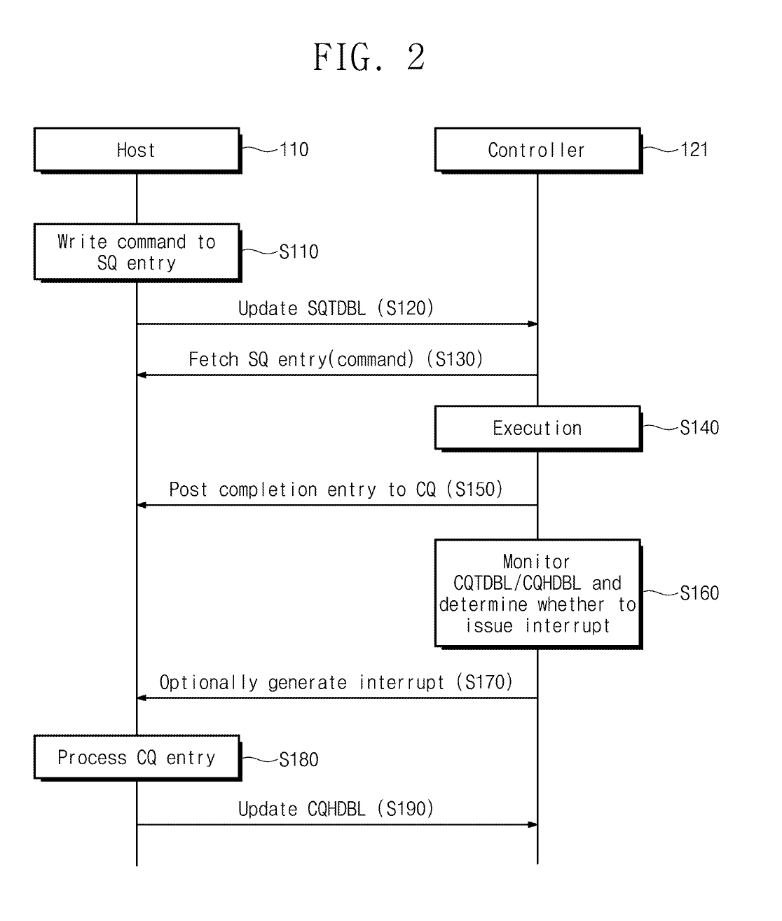

FIG. 2 is an exemplary sequence diagram illustrating an operation between a host and a data storage device illustrated in FIG. 1. FIG. 2 will be described with reference to FIG. 1.

In operation S110, the host 110 may generate a command for accessing the data storage device 120 and may write the command in a submission queue entry. Also, the host 110 may update a submission queue tail.

In operation S120, the host 110 may update the submission queue tail doorbell SQTDBL to provide notification that a new command is written in the submission queue SQ. In particular, the host 110 may write new submission queue tail information (SQTDBL) in the SQTDBL register of the controller 121.

In operation S130, the controller 121 may fetch a submission queue entry with reference to the submission queue tail doorbell SQTDBL. In this case, one or more submission queue entries may be sequentially fetched. Specifically, the controller 121 may sequentially fetch stored commands starting at a submission queue head and ending at a submission queue tail.

In operation S140, the controller 121 may perform an operation corresponding to each of the fetched commands. In this case, the commands stored in the submission queue SQ may be sequentially executed or may not be sequentially executed. The data storage device of FIG. 1 may include a nonvolatile memory or a volatile memory. The controller 121 may execute a command stored in a submission queue entry in consideration of a characteristic of the nonvolatile memory or the volatile memory.

In operation S150, the controller 121 may post a completion queue entry to provide notification that a command fetched from the submission queue SQ is completely executed. In an exemplary embodiment, the size of a completion queue entry may be 16 bytes. The completion queue entry may include a submission queue identifier SQID, a submission queue head pointer SQHD, a status field SF, a phase tag P, a command identifier CID, etc.

In operation S160, the controller 121 may monitor the completion queue tail doorbell CQTDBL and the completion queue head doorbell CQHDBL. As described above, the completion queue tail doorbell CQTDBL may be updated by the controller 121. The completion queue head doorbell CQHDBL may be updated by the host 110. Afterwards, the controller 121 may determine whether to generate an interrupt, based on the monitoring result.

In operation S170, the controller 121 may optionally generate an interrupt and may transfer the interrupt to the host 110. The interrupt may be a pin-based signal or may be transferred as a message signaled interrupt (MSI) or an MSI-X.

In operation S180, the host 110 may process a completion queue entry in response to the interrupt from the controller 121. In particular, the host 110 may perform the interrupt service routine. If a command requested by the host 110 is processed normally, the host 110 may generate a next command corresponding to the command. However, if a command requested by the host 110 is abnormally processed (i.e., results in an error), the host 110 may again generate the command or may perform an operation for recovering an error.

In operation S190, the host 110 may update the completion queue head doorbell CQHDBL to provide notification that the completion queue entry is processed. Specifically, the host 110 may notify the controller 121 that the completion queue head is changed. The updated completion queue head doorbell CQHDBL may be used by the controller 121 in operation S160 that is described above.

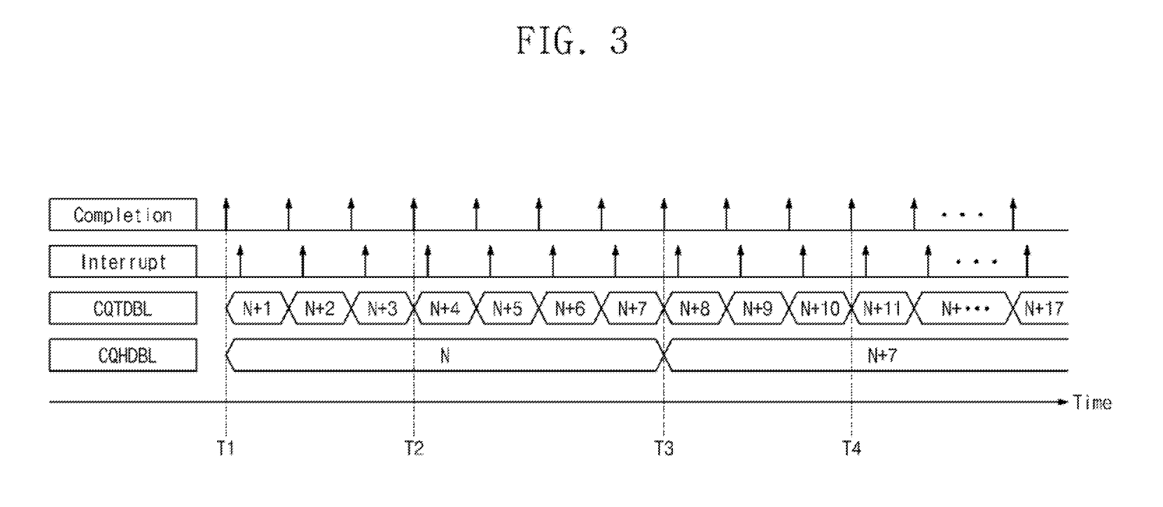

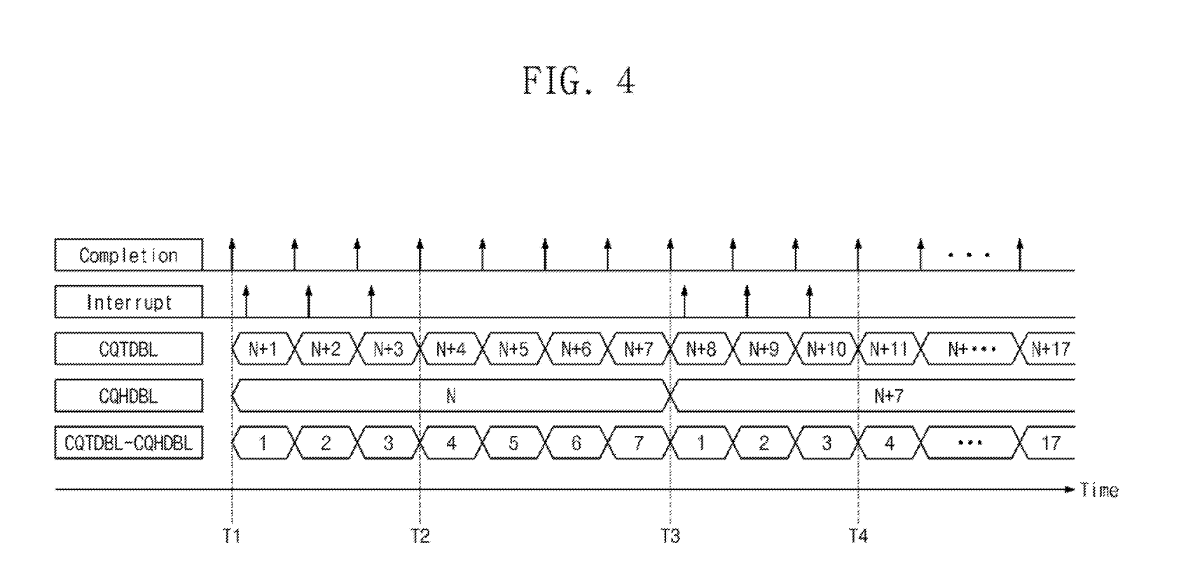

FIGS. 3 and 4 are exemplary timing diagrams illustrating an operation of a controller illustrated in FIG. 1. FIGS. 3 and 4 will be described with reference to FIGS. 1 and 2.

At time T1, the controller 121 may generate a completion signal. Specifically, the controller 121 may post a completion queue entry. After a time elapses from T1, the controller 121 may generate an interrupt. The above-described operation may correspond to operations S150 to S170 of FIG. 2. In FIGS. 3 and 4, the completion queue tail doorbell CQTDBL may be “N+1,” and the completion queue head doorbell CQHDBL may be “N.” Here, “N” may be an integer, and exemplary embodiments of this disclosure may not be limited to the above-described values.

The controller 121 may continue to generate the completion signals from time T1 to time T2. Also, the controller 121 may generate interrupts after a time elapses after generation of the completion signals. Since the controller 121 processed a submission queue entry, the controller 121 may continuously update the completion queue tail doorbell CQTDBL. In FIGS. 3 and 4, the completion queue tail doorbell CQTDBL may be updated sequentially with “N+1,” “N+2,” and “N+3.” However, even though the host 110 receives an interrupt from the controller 121, the host 110 may fail to update the completion queue head doorbell CQHDBL. In an exemplary embodiment, the host 110 may fail to perform the interrupt service routine in an overload state. In this case, the completion queue head doorbell CQHDBL may remain at “N.”

At T2, the controller 121 may still generate a completion signal. However, as shown in FIG. 3, even if the host 110 fails to process an interrupt from a point in time before T2, an interrupt may be still generated. According to an aspect of an exemplary embodiment, however, as illustrated in FIG. 4, the controller 121 may check a difference between the completion queue tail doorbell CQTDBL and the completion queue head doorbell CQHDBL and may decide not to generate an interrupt based on the checked result. In FIG. 4, the host 110 recovers from an overload state relatively rapidly compared with FIG. 3 because the host 110 may not receive an interrupt between T2 and T3. In FIGS. 3 and 4, for ease of description, time T3 is illustrated at the same location, but the time T3 of FIG. 4 may be earlier than that of FIG. 3. That is, the performance of the host 110 may be improved by the controller 121 that is implemented according to an exemplary embodiment.

In an embodiment, the controller 121 may not generate an interrupt when a difference between the completion queue tail doorbell CQTDBL and the completion queue head doorbell CQHDBL is larger than a threshold. In an exemplary embodiment exemplified in FIGS. 3 and 4, the threshold is “3,” but other threshold values may be used as well. The controller 121 may compare a difference between the completion queue tail doorbell CQTDBL and the completion queue head doorbell CQHDBL to the threshold and may generate an interrupt based on the comparison result. According to an aspect of an exemplary embodiment, the threshold may be set by the host 110 or the controller 121.

At T3, the host 110 may update the completion queue head doorbell CQHDBL. Specifically, the completion queue head doorbell CQHDBL may be changed from “N” to “N+7,” that is, may be updated with “N+7.” That is, the host 110 may process a completion queue entry. In this case, the controller 121 may continuously generate a completion signal in the same manner as that before T3. Referring to FIG. 3, an interrupt may be continuously generated regardless of a status of the completion queue CQ. In contrast, as shown in FIG. 4, because a difference between the completion queue tail doorbell CQTDBL and the completion queue head doorbell CQHDBL is smaller than the threshold (e.g., “3”), the controller 121 may generate an interrupt again. That is, according to an embodiment of the inventive concept, the controller 121 may generate an interrupt adaptively in consideration of a processing status of the completion queue CQ. An operation between T3 and T4 may be mostly the same as the operation between T1 and T2 except with regard to the completion queue tail doorbell CQTDBL and the completion queue head doorbell CQHDBL.

At T4, like the operation at T2, the controller 121 may check a difference between the completion queue tail doorbell CQTDBL and the completion queue head doorbell CQHDBL and may not generate an interrupt based on the checked result. As shown in FIG. 4, the controller 121 may refrain from generating an interrupt because a difference between the completion queue tail doorbell CQTDBL and the completion queue head doorbell CQHDBL is larger than the threshold (e.g., “3”).

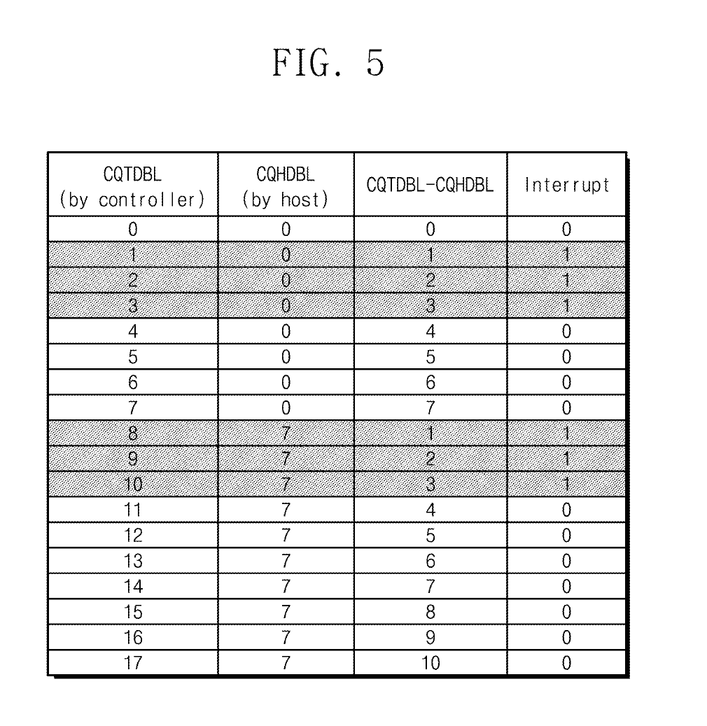

FIG. 5 is an exemplary table illustrating operations of a controller and a host illustrated in FIG. 1. FIG. 5 will be described with reference to FIGS. 1 to 4.

In FIG. 5, the controller 121 may completely process a command of the host 110 and may update the completion queue tail doorbell CQTDBL. The host 110 may process a completion queue entry of the completion queue CQ and may update the completion queue head doorbell CQHDBL. The controller 121 may monitor both the completion queue tail doorbell CQTDBL and the completion queue head doorbell CQHDBL. In particular, the controller 121 may calculate a difference between the completion queue tail doorbell CQTDBL and the completion queue head doorbell CQHDBL. The controller 121 may determine whether to generate an interrupt, based on the calculation result.

In FIG. 5, when the completion queue tail doorbell CQTDBL and the completion queue head doorbell CQHDBL are all “0,” it may signify that the computer system 100 is in its initial state. Afterwards, the completion queue tail doorbell CQTDBL and the completion queue head doorbell CQHDBL may be updated by the controller 121 and the host 110, respectively. The controller 121 may generate an interrupt when a difference between the completion queue tail doorbell CQTDBL and the completion queue head doorbell CQHDBL is not greater than the threshold value (e.g., “3”). This is indicated in the exemplary table as the value of the interrupt being equal to “1.” The controller 121 may not generate an interrupt when a difference between the completion queue tail doorbell CQTDBL and the completion queue head doorbell CQHDBL is greater than the threshold (e.g., “3”), which is indicated by the interrupt value being equal to “0” in the exemplary table. Shaded portions of the table of FIG. 5 may correspond to intervals (e.g., an interval from T1 to T2 and an interval from T3 to T4) of FIG. 4, in which interrupts are generated. Non-shaded portions of the table may correspond to intervals (e.g., an interval from T2 to T3 and an interval after T4) of FIG. 4, in which interrupts are not generated. Exemplary embodiments of the present disclosure may not be limited to values illustrated in FIG. 5.

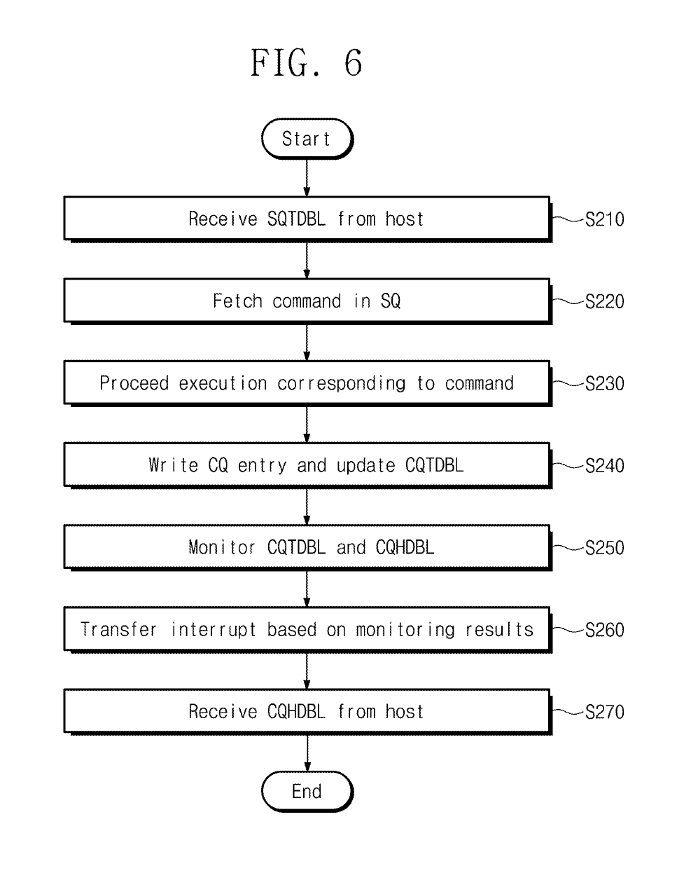

FIG. 6 is a flowchart illustrating an exemplary operation of a controller illustrated in FIG. 1. FIG. 6 will be described with reference to FIGS. 1 and 2.

In operation S210, the controller 121 may receive the submission queue tail doorbell SQTDBL from the host 110. The submission queue tail doorbell SQTDBL may be updated by the host 110. The host 110 may store a command for using the data storage device 120 in a submission queue entry and may update the submission queue tail doorbell SQTDBL. Operation S210 may correspond to operation S120 of FIG. 2.

In operation S220, the controller 121 may fetch a submission queue entry (i.e., a command) from the submission queue SQ. In this case, the controller 121 may fetch submission queue entries sequentially or simultaneously from a submission queue head to a submission queue tail. Operation S220 may correspond to operation S130 of FIG. 2.

In operation S230, the controller 121 may execute a command corresponding to the command fetched in operation S220. The controller 121 may execute the fetched commands in the order that the commands were fetched or may execute the fetched commands in an altered order. Operation S230 may correspond to operation S140 of FIG. 2.

In operation S240, the controller 121 may write a completion queue entry. Operation S240 may be performed after a command fetched from the submission queue SQ is completely executed. The controller 121 may update the completion queue tail doorbell CQTDBL. Updating of the completion queue tail doorbell CQTDBL may signify that a completion queue entry has been newly written (i.e., updated). Operation S240 may correspond to operation S150 of FIG. 2.

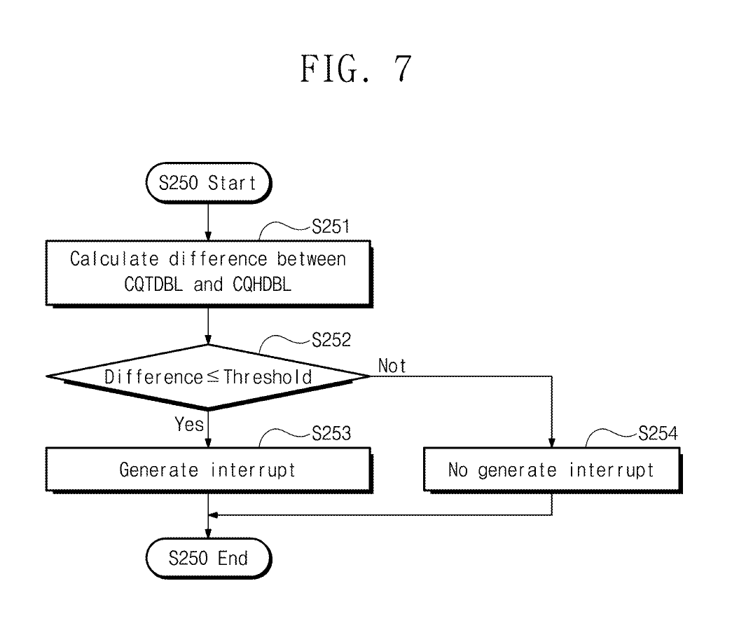

In operation S250, the controller 121 may monitor the completion queue tail doorbell CQTDBL and the completion queue head doorbell CQHDBL. As described above, the controller 121 may check both the completion queue tail doorbell CQTDBL and the completion queue head doorbell CQHDBL. Operation S250 will be described with reference to FIG. 7. Operation S250 may correspond to operation S160 of FIG. 2.

In operation S260, the controller 121 may transfer an interrupt to the host 110 based on the monitoring result. Alternatively, the controller 121 may refrain from transferring the interrupt to the host 110. Operation S260 may correspond to operation S170 of FIG. 2.

In operation S270, the controller 121 may receive the completion queue head doorbell CQHDBL from the host 110. The host 110 may transfer the completion queue head doorbell CQHDBL to the controller 121 to notify the controller 121 of a location of an updated completion queue head. Operation S270 may correspond to operation S190 of FIG. 2.

FIG. 7 is an exemplary flowchart illustrating operation S250 illustrated in FIG. 6. FIG. 7 will be described with reference to FIGS. 1, 2, and 6.

In operation S251, the controller 121 may calculate a difference between the completion queue tail doorbell CQTDBL and the completion queue head doorbell CQHDBL. In an exemplary embodiment, the controller 121 may calculate the difference when updating the completion queue tail doorbell CQTDBL.

In operation S252, the controller 121 may compare a difference between the completion queue tail doorbell CQTDBL and the completion queue head doorbell CQHDBL with a threshold. According to an aspect of an exemplary embodiment, the threshold may be a predetermined and constant value or may be changed by the host 110 or the controller 121, that is, may be a variable value. If the difference between the completion queue tail doorbell CQTDBL and the completion queue head doorbell CQHDBL is not greater than the threshold (“Yes”), the process proceeds to operation S253. If the difference between the completion queue tail doorbell CQTDBL and the completion queue head doorbell CQHDBL is greater than the threshold (“No”), the process proceeds to operation S254.

In operation S253, the controller 121 may generate an interrupt. In contrast, in operation S254, the controller 121 may refrain from generating an interrupt. According to an aspect of an exemplary embodiment, the controller 121 may monitor the completion queue tail doorbell CQTDBL and the completion queue head doorbell CQHDBL and may check a state of the completion queue CQ. That is, the controller 121 may adaptively generate an interrupt in consideration of a status of the completion queue CQ.

FIG. 8 is an exemplary block diagram illustrating a controller illustrated in FIG. 1. As shown in FIG. 8, a controller 200 may include a completion queue tail doorbell register (CQTDBL register) 210, a completion queue head doorbell register (CQHDBL register) 220, a threshold register 230, a calculator 240, and an interrupt controller 250.

Information about a completion queue tail may be stored in the CQTDBL register 210. That is, the controller 200 may write a completion queue entry and may store information about the completion queue tail in the CQTDBL register 210. Because the completion queue tail is updated by the controller 200, the controller 200 may store information about the completion queue tail.

Information about a completion queue head may be stored in the CQHDBL register 220. The host 110 may process a completion queue entry and may update the CQHDBL register 220. That is, the CQHDBL register 220 may be updated by the host 110.

A threshold may be stored in the threshold register 230. The threshold may be used as an indicator for determining the performance of the host 110. As described above, the threshold may be a constant value or may be modified by the host 110 or the controller 200.

The calculator 240 may calculate a difference between the completion queue tail doorbell CQTDBL and the completion queue head doorbell CQHDBL by referring to values of the CQTDBL register 210 and the CQHDBL register 220. The calculator 240 may be implemented with a combination of various logic circuits (e.g., AND, NAND, OR, NOR, XOR, and XNOR). The calculator 240 may transfer the calculation result to the interrupt controller 250.

The interrupt controller 250 may determine whether to generate an interrupt, based on the calculation result and the threshold. As described above, the interrupt controller 250 may generate an interrupt when a difference between the completion queue tail doorbell CQTDBL and the completion queue head doorbell CQHDBL is not greater than the threshold. The interrupt controller 250 may not generate an interrupt when a difference between the completion queue tail doorbell CQTDBL and the completion queue head doorbell CQHDBL is greater than the threshold.

The CQTDBL register 210, the CQHDBL register 220, the threshold register 230, the calculator 240, and the interrupt controller 250 may be implemented with hardware or software. For example, the CQTDBL register 210, the CQHDBL register 220, the threshold register 230, the calculator 240, and the interrupt controller 250 may be implemented with a field programmable gate array (FPGA), an application-specific integrated circuit (ASIC), etc.

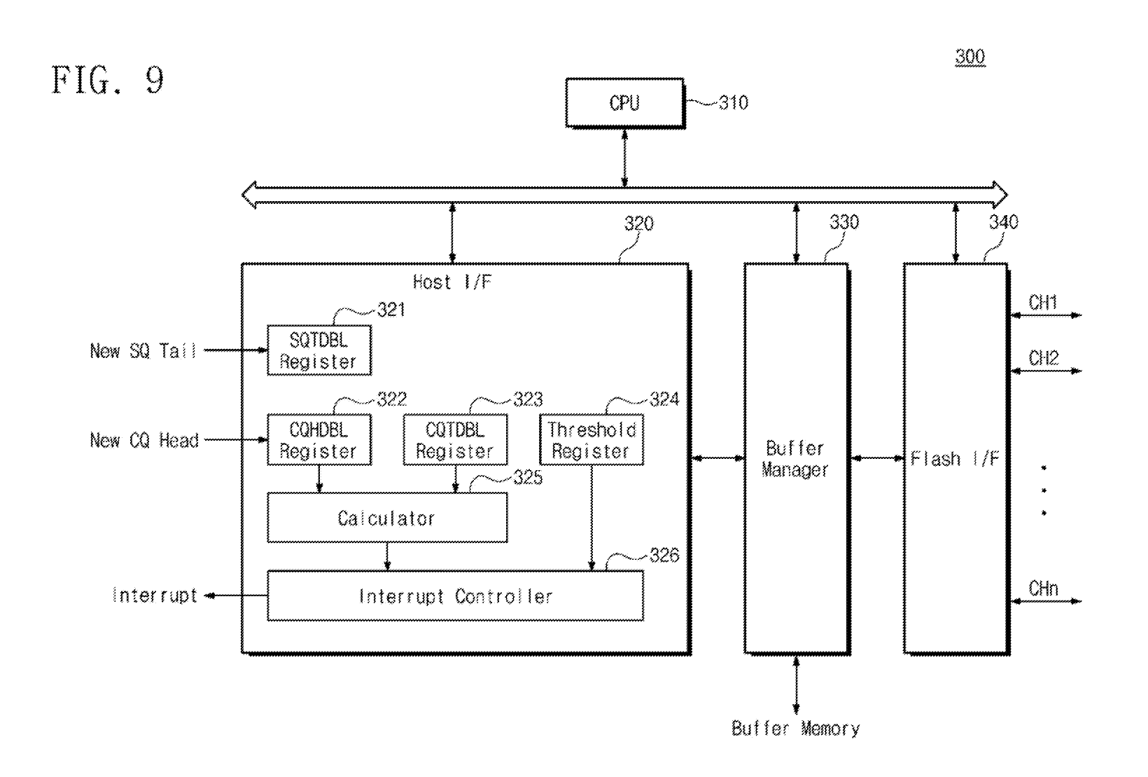

FIG. 9 is an exemplary block diagram illustrating a controller illustrated in FIG. 1. As shown in FIG. 9, a controller 300 may include a central processing unit (CPU) 310, a host interface 320, a buffer manager 330, and a flash interface 340.

The CPU 310 may transfer a variety of information, which is needed to perform a read/write operation on nonvolatile memory devices, to registers of the host interface 320 and flash interface 340. The CPU 310 may operate based on firmware which is provided for various control operations of the memory controller 300. For example, the CPU 310 may execute a flash translation layer (FTL) for performing a garbage collection operation for managing the nonvolatile memory devices, an address mapping operation, a wear leveling operation, etc.

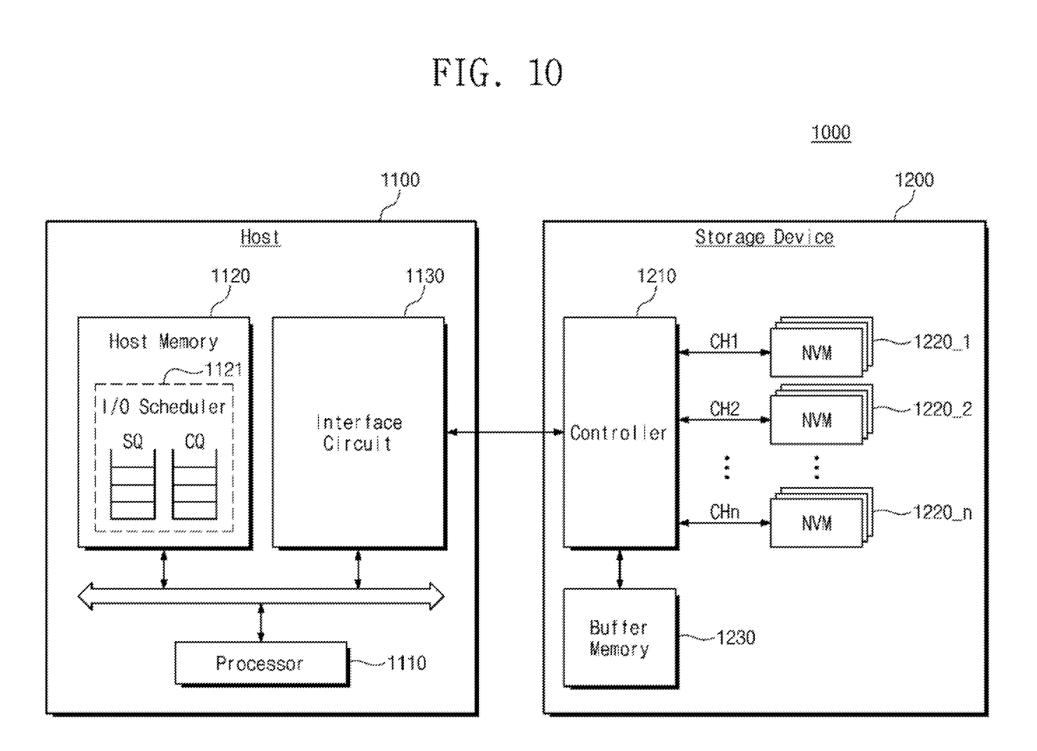

The host interface 320 may include a submission queue tail doorbell register 321, a completion queue head doorbell register 322, a completion queue tail doorbell register 323, a threshold register 324, a calculator 325, and an interrupt controller 326. The host interface 320 may include the SQTDBL register 321 for storing tail information of the submission queue SQ of the host 110. Besides, the CQHDBL register 322, the CQTDBL register 323, the threshold register 324, the calculator 325, and the interrupt controller 326 may be mostly similar to those described with reference to FIG. 8. The host interface 320 may provide an interface corresponding to the bus format of the host. The interfacing will be exemplified in FIG. 10.

In some other exemplary embodiment, the CQTDBL register 323 and the threshold register 324 may be arranged to be separated from the host interface 320. In addition, the controller 300 may not include the CQTDBL register 323 and the threshold register 324 and may store completion queue tail information and threshold information in a buffer memory. As in the above description, the calculator 325 may be arranged to be separated from the host interface 320. In another embodiment, the controller 300 may not include the calculator 325. In this case, a difference between the completion queue tail doorbell CQTDBL and the completion queue head doorbell CQHDBL may be calculated by the CPU 310

The buffer manager 330 may control read and write operations of the buffer memory. The buffer memory may temporarily store write data or read data. The buffer manager 330 may manage a memory area of the buffer memory in units of a stream under control of the CPU 310.

The flash interface 340 may exchange data with a nonvolatile memory device. The flash interface 340 may store data from the buffer memory in the flash memory device through memory channels CH1 to CHn. Data read from the flash memory device may be collected by the flash interface 340. The collected data may be stored in the buffer memory.

FIG. 10 is an exemplary block diagram illustrating a computer system to which a data storage device is applied, according to an exemplary embodiment. As shown in FIG. 10, a computer system 1000 may include a host 1100 and a data storage device 1200. The host 1100 may include a processor 1110, a host memory 1120, and an interface circuit 1130.

The processor 1110 may execute a variety of software (e.g., an application program, an operating system, and a device driver) loaded on the host memory 1120. The processor 1110 may execute an operating system (OS), application programs, etc. The processor 1110 may be implemented with a homogeneous multi-core processor or a heterogeneous multi-core processor.

An application program or data to be processed by the processor 1110 may be loaded on the host memory 1120. An input/output scheduler 1121 for managing a queue, which stores commands to be transferred to the data storage device 1200, may be loaded on the host memory 1120. The submission queue SQ and the completion queue CQ may be managed in the input/output scheduler 1121. The submission queue SQ may be a queue that is written by the host 1100, and commands to be transferred to the data storage device 1200 may be stored in the submission queue SQ. The completion queue CQ may be a queue that is written by the data storage device 1200 and completion information of a command requested by the host 1100 may be stored in the completion queue CQ.

The interface circuit 1130 may provide a physical connection between the host 1100 and the data storage device 1200. That is, the interface circuit 1130 may convert a command, an address, data, etc. corresponding to various access requests issued from the host 1100, to be suitable for an interface with the data storage device 1200. The interface circuit 1130 may be implemented according to at least one of protocols such as universal serial bus (USB), small computer system interface (SCSI), peripheral component interconnect (PCI) express, advanced technology attachment (ATA), parallel ATA (PTA), serial ATA (SATA), and serial attached SCSI (SAS). In an exemplary embodiment, a Non-Volatile Memory express (NVMe) protocol for exchanging data via a PCI express interface may be applied to the interface circuit 1130.

The data storage device 1200 may access nonvolatile memories 1220_1 to 1220_n in response to a command from the host 1100 or may perform various operations that the host 1100 requests. To this end, the data storage device 1200 may include a controller 1210, the nonvolatile memories 1220_1 to 1220_n, and a buffer memory 1230.

The controller 1210 may provide an interface between the host 1100 and the data storage device 1200. According to an aspect of an exemplary embodiment, the controller 1210 may generate an interrupt based on a status of the completion queue CQ.

The buffer memory 1230 may be used as a working memory, a cache memory, or a buffer memory of the controller 1210. The buffer memory 1230 may be used as a cache memory of the nonvolatile memories 1220_1 to 1220_n. The buffer memory 1230 may store codes or commands that the controller 1210 executes. The buffer memory 1230 may store data processed by the controller 1210. In an embodiment, the buffer memory 1230 may include a volatile memory (e.g., a DRAM or an SRAM).

The nonvolatile memories 1220_1 to 1220_n may perform a data input/output operation under control of the controller 1210. For example, the nonvolatile memories 1220_1 to 1220_n may include NAND flash memories, NOR flash memories, ferroelectric random access memories (FRAMs), phase change RAMs (PRAMs), thyristor RAMs (TRAMs), magnetic RAMs (MRAMs), or the like.

According to an aspect of an exemplary embodiment, a data storage device may generate an interrupt in consideration of a completion queue status of a host. Accordingly, the performance of the host may be improved through the data storage device.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A data storage device that is connected with a host, the data storage device comprising:
one or more storage elements; and
a controller configured to execute a command of the host, to update a completion queue of the host, and to transfer an interrupt to the host,
wherein the controller is further configured to monitor a completion queue tail doorbell and a completion queue head doorbell, and generate the interrupt based on a result of the monitoring.

2. The data storage device of claim 1, wherein the controller is further configured to calculate a difference between the completion queue tail doorbell and the completion queue head doorbell.

3. The data storage device of claim 2, wherein the controller is further configured to check a status of the completion queue based on the difference.

4. The data storage device of claim 2, wherein the controller is further configured to generate the interrupt in response to the difference being equal to or less than a threshold, and refrain from generating the interrupt in response to the difference being greater than the threshold.

5. The data storage device of claim 4, wherein the threshold is one of a constant value and a variable value modifiable by the host.

6. The data storage device of claim 1, wherein the controller is further configured to process the command of the host, transfer the completion queue tail doorbell to the host, and receive the completion queue head doorbell from the host.

7. The data storage device of claim 6, further comprising:
a register configured to store the completion queue tail doorbell and the completion queue head doorbell.

8. The data storage device of claim 1, wherein the controller is further configured to communicate with the host based on a non-volatile express (NVMe) interface.

9. An operating method of a data storage device that is connected with a host, the method comprising:
executing a command of the host and updating a completion queue of the host;
monitoring a completion queue tail doorbell and a completion queue head doorbell stored in the data storage device; and
transferring an interrupt to the host based on a result of the monitoring.

10. The method of claim 9, wherein the monitoring comprises:
calculating a difference between the completion queue tail doorbell and the completion queue head doorbell; and
comparing the difference to a threshold.

11. The method of claim 10, wherein the transferring the interrupt to the host comprises:
generating the interrupt in response to the difference being equal to or less than the threshold; and
refraining from generating the interrupt in response to the difference being greater than the threshold.

12. The method of claim 10, wherein the threshold is one of a constant value and a variable value modifiable by the host.

13. The method of claim 10, wherein the calculating comprises:
storing the completion queue tail doorbell, the completion queue head doorbell, and the difference.

14. The method of claim 13, wherein the calculating further comprises:
checking a status of the completion queue based on the difference.

15. The method of claim 9, wherein the updating comprises:
transferring the completion queue tail doorbell to the host; and
receiving the completion queue head doorbell from the host.

16. A non-transitory computer-readable storage medium storing instructions which, when executed by a processor, cause the processor to perform operations comprising:
updating a first position of a completion queue head doorbell in a completion queue head doorbell register of a data storage device, wherein the completion queue head doorbell is a first pointer that corresponds to a head of a completion queue stored inside a host that communicates with the data storage device;
updating a second position of a completion queue tail doorbell in a completion queue tail doorbell register of the data storage device, wherein the completion queue tail doorbell is a second pointer that corresponds to a tail of the completion queue stored inside the host;
comparing a positional distance between the first position and the second position; and;
in response to the positional distance between the first positional and the second position being less than a threshold value, issuing an interrupt by the data storage device to the host.

17. The non-transitory computer-readable storage medium of claim 16, storing additional instructions which, when executed by the processor, cause the processor to perform further operations comprising:
in response to the positional distance between the first positional and the second position being equal to or greater than the threshold value, withholding the interrupt from being issued by the data storage device to the host.

18. The non-transitory computer-readable storage medium of claim 16, wherein the data storage device is a solid-state drive.

19. The non-transitory computer-readable storage medium of claim 16, storing additional instructions which, when executed by the processor, cause the processor to perform further operations comprising:
receiving by the data storage device a notification from the host, the notification indicating completion of an entry to the completion queue,
wherein the updating the first position of the completion queue head doorbell is based on the notification.

20. The non-transitory computer-readable storage medium of claim 16, storing additional instructions which, when executed by the processor, cause the processor to perform further operations comprising:
receiving by the data storage device a command from the host,
wherein the updating the second position of the completion queue tail doorbell is performed upon completion of the command by the data storage device.
